(19) United States
(12) Patent Application Publication
(10) Pub. No.: US 2026/0117563 A1
(43) Pub. Date: Apr. 30, 2026

(54) Security Devices

(71) Applicant: Zeal Innovation Ltd, Swansea (GB)

(72) Inventor: Neil Anthony BARRON, Swansea (GB)

(21) Appl. No.: 19/431,625

(22) Filed: Dec. 23, 2025

Related U.S. Application Data
(63) Continuation of application No. 18/550,719, now Pat. No. 12,559,990.

(30) Foreign Application Priority Data
Mar. 15, 2021 (GB) 2103571.2

(51) Int. Cl. E05B 71/00; D07B 1/06; D07B 1/16

(52) U.S. Cl. CPC E05B 71/00; D07B 1/0673; D07B 1/162; D07B 2201/104; D07B 2201/2041; D07B 2201/2066; D07B 2201/2082; D07B 2201/2084; D07B 2201/2092

(57) ABSTRACT

An elongate body adapted to bend in a single plane, includes a rope extending within a succession of individual tubular elements closely spaced along the rope. Each element has on two opposite sides of the plane an extended section engaging a recess in its neighbouring element, the profiles of the section and recess allowing relative rotation of adjacent elements in the plane. The tubular elements thus form an exoskeleton around the rope which must be breached before the rope can be cut. The geometry of the tubular elements can be such that notwithstanding gaps, the rope cannot be readily accessed unless the exoskeleton is broken.

This application is a continuation of U.S. patent application Ser. No. 18/550,719, filed on Sep. 15, 2023, which is a U.S. national phase application of International Patent Application. No. PCT/GB2022/050665, filed on Mar. 15, 2022, which, in turn, is based upon and claims the right of priority to GB Patent Application No. 2103571.2, filed on Mar. 15, 2021, the disclosures of which are hereby incorporated by reference herein in their entireties for all purposes.

This invention relates to security devices, and has particular application in security devices in which two ends of an elongate body must be held together. Such devices can be used for securing baggage and light vehicles in the manner described in various Patent publications including International Specification Nos. WO2010/103327 and WO2015/087067; and U.S. Pat. Nos. 5,706,679 and 6,510,717, the disclosures whereof are hereby incorporated by reference. The present invention is directed at such an elongate body in the form of a flexible body, which can also be used as part of a flexible plate or planar item. The object of the invention is provide a body that offers increased resistance to attempts to cut it. Reference is also directed to US Patent Publication No. 2013/0068341A1 which discloses a cable sheath comprising connected plural tubes.

According to the present invention an elongate body adapted to bend in a single plane, comprises a rope extending within a succession of individual tubular elements closely spaced along the rope. Each element has on two opposite sides of the plane an extended section engaging a recess in its neighbouring element, the profiles of the section and recess allowing relative rotation of adjacent elements in said plane. The elements are independent of each other and there is no radial engagement or overlap between adjacent elements. The tubular elements thus form an exoskeleton around the rope which must be breached before the rope can be cut. The geometry of the tubular elements can be such that notwithstanding gaps, the rope cannot be readily accessed unless the exoskeleton is broken.

The rope which defines the axis of the elongate body of the invention is normally a wire rope, preferably a compacted wire rope. Such a rope may comprise metallic strands wound round an helically wound metallic core. In some embodiments, the rope can be replaced by a chain. However, the rope May serve a particular purpose such as an electronic conductor or carrier for fluids; gas or liquid. The term “rope” should be understood to have this broad meaning in the context of this Application.

Preferred embodiments of the invention have restricted bending in one direction in their bending plane. This can be accomplished by using tubular elements that have on a third side substantially perpendicular to the plane juxtaposed sections that engage when the body is sought to be bent in that one direction. In this arrangement the respective element sections can be designed to engage when the body is substantially straight.

Each tubular element will normally comprise a cut-resistant material. Examples of suitable materials are cermet; tungsten carbide; titanium carbide; titanium nitride, and titanium carbon nitride. The cut-resistant material will not usually form the entirety of each element, but can be part of it or coated on the element. This can be accomplished by flame spraying or laser cladding.

Each tubular element in an elongate body according to the invention can be a solid, preferably metallic tube; cast, moulded or fabricated, but is preferably a skeletal structure or a perforated tube. For example, a fabricated element might comprise a single metal pressing cut to shape and closed into a tube with the closing edges secured by one of crimping clinching and welding. Another might comprise two matching metal pressings cut to shape and closed into a tube with the closing edges secured by one of crimping clinching and welding. Such fabricated elements can be formed with ridges creating a channel for reinforcing strips. However, in all embodiments of the invention some form of reinforcing strip may be provided, preferably on at least one side of said plane and aligned with the engaging extended sections and recesses.

In order to accommodate bending the rope in a body according to the invention must be allowed to move relative to the surrounding tubular elements. Typically, each end of the exoskeleton will be received in a shell attached to the rope, allowing axial movement of the respective tubular elements within the shells corresponding to that required as the body is bent. The rope may extend beyond one shell or both shells depending upon the application of the body. Alternatively, each shell may be fixedly attached to a rope end to define the length of the body. Such shells may be locking units, for attachment to each other or to separate parts of a closure. Elongate bodies according to the invention thus have particular use in security devices. A simple such device will be a body of the invention including complementary locking units at respective ends thereof. A typical use will be as a bicycle or motorcycle lock.

Relative movement of the rope and tubular elements can also be accommodated by the spacing or degree of engagement of the elements with the elements at each end of the body being fixed to the rope. Close engagement of the elements will result in the body being stiff with relatively limited bending. The looser the engagement between the elements the more bending will be possible. When designed to close as a loop as in a cycle lock for example, it is recommended that the engagement is such that the body can be bent to close and lock the ends together with the body substantially rigid.

Another use for bodies of the invention is in the formation of a flexible plate. A plurality of bodies may be laid side to side in a plane common with the bending plane with the tubular elements in each body linked to those in the neighbouring body.

The invention will now be described by way of example and with reference to the accompanying schematic drawings wherein:

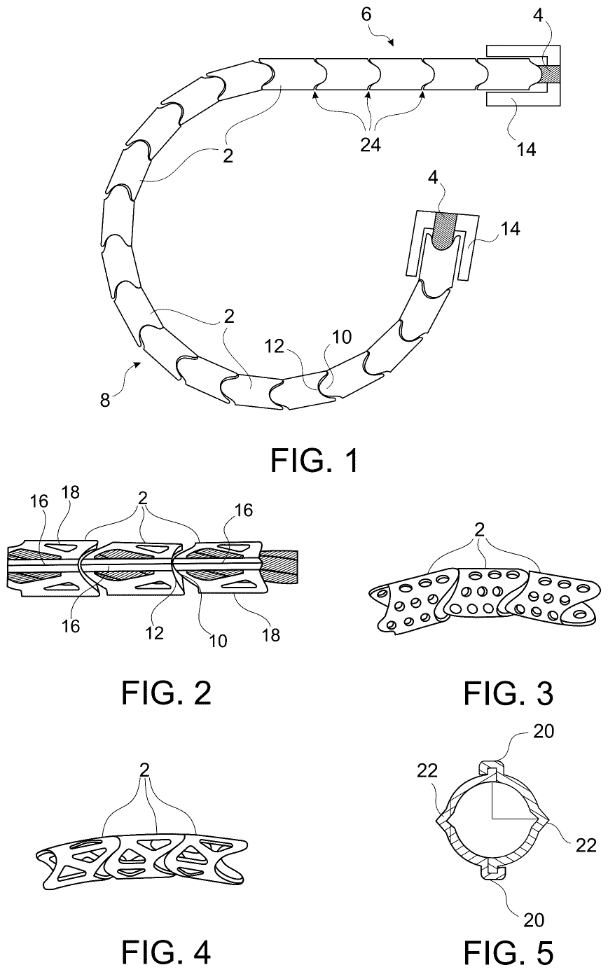

FIG. 1 shows an elongate body according to the invention, part broken to illustrate the end units;

FIG. 2 shows tubular elements having a skeletal structure in a body of the invention;

FIGS. 3 and 4 are perspective views of different forms of tubular elements;

FIG. 5 shows a cross section through a tubular element formed from two components;

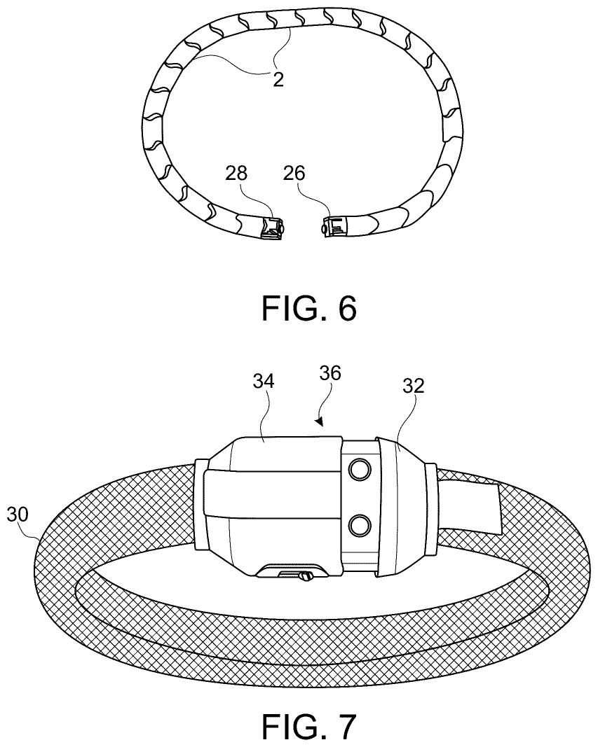

FIG. 6 shows an elongate body according to the invention extended to form a security device; and

FIG. 7 shows a security device comprising an elongate body similar to that of FIG. 6.

The elongate body shown in FIG. 1 has a plurality of tubular bodies 2 inter-engaging along a length 4 of rope. The body is arranged with a straight section 6 and a section 8 curved in a single plane. Each element has an extension 10 which is received in a recess 12 in its neighbour. The elements 2 are not connected, but in close engagement, and the matched arcuate edges of the extension 10 and recess 12 allow rotation of each element relative to its neighbour. Their close engagement means that when the body is bent in a direction that increases that engagement the extension and recess make contact and prevent or restrict such bending. The elements 2 are formed with similarly arranged extensions and recesses on the opposite side of the rope 4. In this way, bending of the body is restricted to substantially a single plane. An arrangement of extensions and recesses are also formed on the outer and inner sides of the bent body shown on FIG. 1, to allow bending in the direction illustrated, but prevent bending in the other direction beyond the straight. As can be seen the outer extensions and recesses are in contact and the inner extensions and recesses are separated in the straight section 6. In this way the design of the inner and outer profiles of the tubular elements sets the limits to which the body can bend in either direction in its bending plane.

The rope 4 is normally a metal rope comprising twisted strands or compacted wire, and a typical diameter is 10-20 mm. The tubular elements are a relatively close fit around the rope sufficient to allow axial movement and have a wall thickness of 7-15% of the rope diameter. Their radial thickness will though depend upon the material in which they are formed, and their length as shown L, from the peak of the extended section to the base of the recess, is around twice the rope diameter.

A typical body according to the invention has a standard 14 mm metal rope within steel tubular elements with a wall thickness of around 1.5 mm (9-10% of the rope diameter). The length L of each element is around twice the rope diameter; say 30 mm, with the overall length being around 40 mm. The full depth of each extension and recess is around 10 mm.

In order to accommodate bending of the body the extended section 10 and recesses 12 at the ends of the tubular elements do not match. For example, the recesses can be more shallow than extensions to allow bending in both senses from straight. However, in the illustrated embodiment one edge of each recess is cut away or omitted as indicated at 24 to allow bending from straight in only the sense shown. The cutaway is typically 2-3 mm, but may be selected depending upon what maximum curvature of the body is required.

At each end of the body in FIG. 1 the rope 4 is attached to a shell 14, shown in cross section, which receives the respective terminal tubular element 2. The body is shown at its limit of bending and as a consequence the shells 14 substantially enclose both terminal elements. It will be understood that one or both of the shells and tubular elements will determine the limit to which the body may bend.

The body shown in FIG. 1 illustrates its construction. It will be appreciated that it may be extended or shortened for use in a particular application. For example, in an extended form the shells 14 may be, or be attached to complementary locking units such that the body as a whole forms a lockable loop for use as a bicycle or motorcycle lock. In a shortened form, it could be used to simply lock one item to another with one or both shells being releasably attached to the respective items.

FIG. 2 shows a train of tubular elements 2, each of which is a metal casting forming a skeletal structure. Extending between each extension 10 and recess 12 is a reinforcing strip 16 of cut resistant material such as cermet; tungsten carbide; titanium carbide; titanium nitride, and titanium carbon nitride. A similar strip is formed on the opposite side, and may also be formed on one or both of the outer and inner sides of the bent body as shown at 18. Of course, the entire element can be formed in a cut-resistant material, but for most applications strips such as are shown here are sufficient, and applied to elements cast in other materials such as metal alloys. The strips will be disposed such that they overlap on at least two sides to avoid gaps that might provide access for a conventional wire cutter whether the body is bent or straight.

FIGS. 3 and 4 show different designs of tubular elements 2 formed from metal pressings. They have holes which reduce their weight, but these openings, like those in the skeletal structure of FIG. 2 are shaped and located not to facilitate access to the rope in an attempt to cut the body as a whole. A pressed element may be formed from a single pressing or matching pressings shaped and crimped, clinched or welded to form a tube. Cut-resistant material may be applied to these elements, but it is preferred to do so in the manner described below with reference to FIG. 5.

FIG. 5 shows the cross section of a tubular element formed from two identical pressings, crimped, clinched or welded together at the edges 20. The cross section shown also has ridges 22 creating internal channels for a cut-resistant material. It will be appreciated that the pressings may be shaped to form different channels, internal or external, for cut-resistant materials which can be applied by for example flame spraying or laser cladding.

The security device shown in FIG. 6 is a body similar to that of FIG. 1, but of extended length to enable it to complete a loop as in a bicycle or motorcycle lock. At each end of the body an adapted tubular element 26, 28 forms a shell which receives and retains the rope. The elements 26 and 28 may be coupled by a locking mechanism (not shown), directly or indirectly, to close the loop. The mechanism can comprise male and female lock units forming part of the elements 26, 28, or a separate unit into which the respective elements can be locked. The body will normally be contained within a polymeric cover (not shown), and may be enclosed in a fabric sleeve 30 as illustrated in the embodiment of FIG. 7. As can be seen in FIG. 7 the ends of the body (cover) and sleeve are received in units 32 and 34 of a lock 36. In each of the embodiments of FIGS. 6 and 7 the body in the shape illustrated is quite stiff, bending of the body having brought the tubular elements into close engagement to inhibit further flexure.

1. An elongate body adapted to bend in a single plane, comprising:
a rope extending within a succession of individual tubular elements closely spaced along the rope, each tubular element having on two opposite sides of the plane an extended section engaging a recess in its neighbouring element, the profiles of the section and recess allowing relative rotation of adjacent elements in the plane,
wherein each tubular element comprises a single metal pressing cut to shape and closed into a tube with closing edges secured by one of crimping, clinching, and welding;
or
wherein each element comprises two matching metal pressings cut to shape and closed into a tube with the closing edges secured by one of crimping, clinching, and welding.

2. The elongate body according to claim 1, wherein the rope is a wire rope.

3. The elongate body according to claim 2, wherein the rope is a compacted wire rope.

4. The elongate body according to claim 2, wherein the rope comprises metallic strands wound round a helically wound metallic core.

5. The elongate body according to claim 1, wherein the extended sections and recesses on the two opposite sides define limits to which the body can be bent in both senses in the plane.

6. The elongate body according to claim 1, wherein the tubular elements have on a third side, substantially perpendicular to the plane, juxtaposed sections that restrict bending of the body to one direction in the plane.

7. The elongate body according to claim 1, wherein each tubular element comprises a cut-resistant material.

8. The elongate body according to claim 1, including shims or a resin polymer filler around the rope within each tubular element.

9. The elongate body according to claim 1, wherein each tubular element is a skeletal structure.

10. The elongate body according to claim 1, wherein each tubular element is a perforated tube.

11. The elongate body according to claim 1, wherein the metal pressings are formed with ridges creating a channel for reinforcing strips.

12. The elongate body according to claim 1, wherein each tubular element has on at least one side of the plane, a reinforcing strip aligned with the engaging 6 extended sections and recesses.

13. The elongate body according to claim 1, wherein each element comprises a cut-resistant material.

14. The elongate body according to claim 13, wherein the cut-resistant material is applied to each tubular element.

15. The elongate body of claim 14, further including complementary locking units at respective ends of the elongate body.

16. A security device comprising the elongate body according to claim 1.

17. The security device according to claim 16, wherein each end of the succession of tubular elements is received in a shell attached to an end of the rope.

18. The security device according to claim 17, wherein when the elongate body is at its limit of bending, the shells enclose the ends of the succession of tubular elements.

19. A flexible plate comprising a plurality of bodies, wherein each body is adapted to bend in a single plane and comprises a rope extending within a succession of individual tubular elements closely spaced along the rope; each element in the succession having, on two opposite sides of the plane, an extended section engaging a recess in its neighbouring element, the profiles of the section and recess allowing relative rotation of adjacent elements in the plane, and wherein the bodies are laid side to side with tubular elements in each body linked to those in the neighbouring body;
wherein each element comprises a single metal pressing cut to shape and closed into a tube with closing edges secured by one of crimping, clinching, and welding;
or
wherein each element comprises two matching metal pressings cut to shape and closed into a tube with the closing edges secured by one of crimping, clinching, and welding.

20. A security device comprising an elongate body adapted to bend in a single plane, comprising: a rope extending within a succession of individual tubular elements closely spaced along the rope, each element having, on two opposite sides of the plane, an extended section engaging a recess in its neighbouring element, the profiles of the section and recess allowing relative rotation of adjacent elements in the plane but define limits to which the body can be bent in the plane, the tubular elements having on a third side, substantially perpendicular to the plane, juxtaposed sections that restrict bending of the body to one direction in the plane, and wherein a cut-resistant material is applied to each tubular element;
wherein each element comprises a single metal pressing cut to shape and closed into a tube with closing edges secured by one of crimping, clinching, and welding;
or
wherein each element comprises two matching metal pressings cut to shape and closed into a tube with the closing edges secured by one of crimping, clinching, and welding.

21. The security device according to claim 20, wherein each tubular element has, on at least one side of the plane, a reinforcing strip of cut-resistant material aligned with the engaging extended sections and recesses.
